(19) United States
(12) Patent Application Publication
(10) Pub. No.: US 2025/0119305 A1
(43) Pub. Date: Apr. 10, 2025

(54) HYBRID BOND PHYSICAL UNCLONABLE FUNCTION (PUF) SECURITY STRUCTURE

(71) Applicant: INTERNATIONAL BUSINESS MACHINES CORPORATION, ARMONK, NY (US)

(72) Inventor: Nicholas Alexander Polomoff, Hopewell Junction, NY (US)

(21) Appl. No.: 18/482,879

(22) Filed: Oct. 7, 2023

(51) Int. Cl. H04L 9/32

(52) U.S. Cl. CPC H04L 9/3278

(57) ABSTRACT

A semiconductor package includes a physical unclonable function (PUF) security device. Two or more dies of the PUF security device has an interface surface joined together with another die by a hybrid bond. A portion of each interface surface has an inlayed or an embedded structure. The inlayed or the embedded structure of the interface surface of each die has particulates with a different amount of dispersion or concentration.

### BACKGROUND

### Technical Field

The present disclosure generally relates to computer software security, and more particularly, to physically unclonable function (PUF) devices.

### Description of the Related Art

A physical unclonable function (PUF) is a device designed to have a unique fingerprint due to unique physical variations that occur during the manufacturing process. These variations in the structure result in each PUF device may result in having differing voltage gains, transistor threshold voltages, path delays, etc. as compared to other PUF devices.

The random variations are deterministic and repeatable once identified. A PUF structure may be designed to take advantage of the variations in circuit structure to generate a unique cryptographic key. For example, the dispersion of particles in each PUF device results in unique physical variations in their structure. The unique variations result in an electrical signal in the PUF that cannot be duplicated. The electrical signal may be leveraged for security features in applications such as anti-counterfeiting, identification, authentication, and key generation. However, there is a certain amount of disruption to a semiconductor manufacturing process to include a PUF structure.

### SUMMARY

A semiconductor package includes a physical unclonable function (PUF) security device structure that is fabricated through the leveraging of hybrid bonding-based manufacturing techniques. Two or more dies are bonded or joined together through the use of a hybrid bonding technique to form a PUF structure at the interface surface of the adjoined semiconductor parts. A portion of each interface surface has an inlayed or an embedded structure. The inlayed or the embedded structure of the interface surface of each die has particulates with a different amount of dispersion.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 is a perspective view of a hybrid bonded physical unclonable function (PUF) device, consistent with an illustrative embodiment.

FIG. 2 is a perspective view of a semiconductor package including a PUF device, consistent with an illustrative embodiment.

FIGS. 3A and 3B show a front view and a cross-sectional side view of a semiconductor package with a PUF device constructed of the same material with slightly different compositions, consistent with an illustrated embodiment.

FIGS. 3C and 3D show a front view and a cross-sectional side view of a semiconductor package with a PUF device constructed of different materials, consistent with an illustrated embodiment.

FIGS. 3E and 3F show a front view and a cross-sectional side view of a semiconductor package with a PUF device constructed of the same material with different concentrations, consistent with an illustrated embodiment.

FIGS. 4A and 4B illustrate a perspective view and a cross-sectional side view of a first variant of pads in a PUF structure, consistent with an illustrated embodiment.

FIGS. 4C and 4D illustrate a perspective view and a cross-sectional side view of a second variant of pads in a PUF structure, consistent with an illustrated embodiment.

FIGS. 4E and 4F illustrate a perspective view and a cross-sectional side view of a third variant of pads in a PUF structure, consistent with an illustrated embodiment.

FIGS. 4G and 4H illustrate a perspective view and a cross-sectional side view of a fourth variant of pads in a PUF structure, consistent with an illustrated embodiment.

FIG. 5 illustrates a semiconductor package including a PUF device and some physical variations that enhance the security of the semiconductor package, consistent with an illustrated embodiment.

FIG. 6 illustrates the capacitive coupling of an interlocking finger pattern and coating layer of a PUF security device, consistent with an illustrated embodiment.

FIG. 7A illustrates a start of the process flow to build a bonded PUF structure in which two plates are arranged in a substrate with a pad, consistent with an illustrated embodiment.

FIG. 7B illustrates a reactive ion etching (RIE) operation is performed to open the substrate to permit a build of a PUF structure, consistent with an illustrative embodiment.

FIG. 7C illustrates capacitive material in the form of particulates is arranged both in the etched opening and along an upper surface of the substrate, consistent with an illustrative embodiment.

FIG. 7D illustrates a heat treatment/curing operation of the PUF capacitive material is performed, consistent with an illustrative embodiment.

FIG. 7E illustrates the cured PUF capacitive material is planarized to remove the material along the surface of the substrate, consistent with an illustrative embodiment.

FIG. 8A illustrates the start of a hybrid bonding process of two dies of a semiconductor package, consistent with an illustrative embodiment.

FIG. 8B illustrates that one of the dies shown in FIG. 8A is flipped and aligned for bonding, consistent with an illustrative embodiment.

FIG. 8C illustrates two dies shown in FIG. 8C are arranged together for hybrid bonding by a heat-based process, consistent with an illustrative embodiment.

### DETAILED DESCRIPTION

In the following detailed description, numerous specific details are set forth by way of examples to provide a thorough understanding of the relevant teachings. However, it is to be understood that the present teachings may be practiced without such details. In other instances, well-known methods, procedures, components, and/or circuitry have been described at a relatively high-level, without detail, to avoid unnecessarily obscuring aspects of the present teachings. It is also to be understood that the present disclosure is not limited to the depictions in the drawings, as there may be fewer elements or more elements than shown and described.

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

In one aspect, spatially related terminology such as “front,” “back,” “top,” “bottom,” “beneath,” “below,” “lower,” above,” “upper,” “side,” “left,” “right,” and the like, is used with reference to the orientation of the Figures being described. Since components of embodiments of the disclosure can be positioned in a number of different orientations, the directional terminology is used for purposes of illustration and is in no way limiting. Thus, it will be understood that the spatially relative terminology is intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

As used herein, the terms “lateral” and “horizontal” describe an orientation parallel to a first surface of a chip. The term “vertical” describes an orientation that is arranged perpendicular to the first surface of a chip, chip carrier, or semiconductor body.

As used herein, the terms “coupled” and/or “electrically coupled” are not meant to mean that the elements must be directly coupled together-intervening elements may be provided between the “coupled” or “electrically coupled” elements. In contrast, if an element is referred to as being “directly connected” or “directly coupled” to another element, there are no intervening elements present. The term “electrically connected” refers to a low-ohmic electric connection between the elements electrically connected together.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

Example embodiments are described herein with reference to cross-sectional illustrations that are schematic illustrations of idealized or simplified embodiments (and intermediate structures). As such, variations from the shapes of the illustrations as a result, for example, of manufacturing techniques and/or tolerances, may be expected. Thus, the regions illustrated in the figures are schematic in nature and their shapes do not necessarily illustrate the actual shape of a region of a device and do not limit the scope.

It is to be understood that other embodiments may be used and structural or logical changes may be made without departing from the spirit and scope defined by the claims. The description of the embodiments is not limiting. In particular, elements of the embodiments described hereinafter may be combined with elements of different embodiments.

The term “semiconductor” as used herein denotes any semiconducting material including, for example, Si, Ge, SiGe, SiC, SiGeC, and III-V compound semiconductors such as InAs, GaAs and InP. The substrate can be made of any suitable substrate material, such as, for example, monocrystalline Si, silicon germanium (SiGe), III-V compound semiconductor, II-VI compound semiconductor, or semiconductor-on-insulator (SOI). Group III-V compound semiconductors, for example, include materials having at least one group III element and at least one group V element, such as one or more of aluminum gallium arsenide (AlGaAs), aluminum gallium nitride (AlGaN), aluminum arsenide (AlAs), aluminum indium arsenide (AlIAs), aluminum nitride (AlN), gallium antimonide (GaSb), gallium aluminum antimonide (GaAlSb), gallium arsenide (GaAs), gallium arsenide antimonide (GaAsSb), gallium nitride (GaN), indium antimonide (InSb), indium arsenide (InAs), indium gallium arsenide (InGaAs), indium gallium arsenide phosphide (InGaAsP), indium gallium nitride (InGaN), indium nitride (InN), indium phosphide (InP) and alloy combinations including at least one of the foregoing materials. The alloy combinations can include binary (two elements, e.g., gallium (III) arsenide (GaAs)), ternary (three elements, e.g., InGaAs) and quaternary (four elements, e.g., aluminum gallium indium phosphide (AlInGaP)) alloys.

In some embodiments, the substrate can include a buried oxide layer in a silicon-on-insulator (SOI) configuration. The buried oxide layer can be made of any suitable dielectric material, such as, for example, a silicon oxide. In some embodiments of the disclosure, the buried oxide layer is formed to a thickness of about 10-200 nm, although other thicknesses are within the contemplated scope of the disclosure. In some embodiments of the disclosure, the semiconductor structure can also be formed without the buried oxide layer. In that case, an STI (shallow trench isolation) may be formed to isolate devices.

To that end, in some embodiments, etching mask layer(s) may be provided, and the layers that are not protected thereby are removed. For example, as is understood by those of ordinary skill in the art, a mask layer (not shown), sometimes referred to as a photomask, may be provided by forming a layer of photoresist material on the amorphous SiO₂ layer, exposing the photoresist material to a pattern of light, and developing the exposed photoresist material. An etching process, such as a reactive ion etch (RIE), may be used to form patterns (e.g., openings) by removing portions of the amorphous SiO₂ layer and conductive oxide diffusion barrier, up to the top surface of the first electrode layer. After etching, the mask layer may be removed using a conventional plasma ashing or stripping process. Accordingly, the pattern of the mask layer facilitates the removal of the amorphous SiO₂ layer and conductive oxide diffusion barrier, in areas where the mask layer has not been deposited, thereby leaving behind two regions. A similar process may be used to pattern the first electrode layer (e.g., before the conductive oxide diffusion barrier is provided thereon).

For the sake of brevity, conventional techniques related to semiconductor device and integrated circuit (IC) fabrication may or may not be described in detail herein. Moreover, the various tasks and process steps described herein can be incorporated into a more comprehensive procedure or process having additional steps or functionality not described in detail herein. In particular, various steps in the manufacture of semiconductor devices and semiconductor-based ICs are well known and so, in the interest of brevity, many conventional steps will only be mentioned briefly herein or will be omitted entirely without providing the well-known process details.

Fabrication of semiconductor devices can include multi-step sequences of, for example, photolithographic and/or chemical processing steps that facilitate gradual creation of electronic-based systems, devices, components, and/or circuits in a semiconducting and/or a superconducting device (e.g., an integrated circuit). For instance, a device can be fabricated on one or more substrates (e.g., a silicon (Si) substrates, and/or another substrate) by employing techniques including, but not limited to: photolithography, microlithography, nanolithography, nanoimprint lithography, photomasking techniques, patterning techniques, photoresist techniques (e.g., positive-tone photoresist, negative-tone photoresist, hybrid-tone photoresist, and/or another photoresist technique), etching techniques (e.g., reactive ion etching (RIE), dry etching, wet etching, ion beam etching, plasma etching, laser ablation, and/or another etching technique), evaporation techniques, sputtering techniques, plasma ashing techniques, thermal treatments (e.g., rapid thermal anneal, furnace anneals, thermal oxidation, and/or another thermal treatment), chemical vapor deposition (CVD), atomic layer deposition (ALD), physical vapor deposition (PVD), molecular beam epitaxy (MBE), electrochemical deposition (ECD), chemical-mechanical planarization (CMP), back grinding techniques, and/or another technique for fabricating an integrated circuit.

In general, the various processes used to form a micro-chip that will be packaged into an IC fall into four general categories, namely, film deposition, removal/etching, semiconductor doping and patterning/lithography. Deposition is any process that grows, coats, or otherwise transfers a material onto the wafer. Available technologies include physical vapor deposition (PVD), chemical vapor deposition (CVD), electrochemical deposition (ECD), molecular beam epitaxy (MBE) and more recently, atomic layer deposition (ALD) among others. Removal/etching is any process that removes material from the wafer. Examples include etch processes (either wet or dry), chemical-mechanical planarization (CMP), and the like. Reactive ion etching (ME), for example, is a type of dry etching that uses chemically reactive plasma to remove a material, such as a masked pattern of semiconductor material, by exposing the material to a bombardment of ions that dislodge portions of the material from the exposed surface. The plasma is typically generated under low pressure (vacuum) by an electromagnetic field.

Semiconductor doping is the modification of electrical properties by doping, for example, transistor sources and drains, generally by diffusion and/or by ion implantation. These doping processes are followed by furnace annealing or by rapid thermal annealing (RTA). Annealing serves to activate the implanted dopants. Films of both conductors (e.g., poly-silicon, aluminum, copper, etc.,) and insulators (e.g., various forms of silicon dioxide, silicon nitride, etc.) are used to connect and isolate transistors and their components. Selective doping of various regions of the semiconductor substrate allows the conductivity of the substrate to be changed with the application of voltage. By creating structures of these various components, millions of transistors can be built and wired together to form the complex circuitry of a modern microelectronic device. Semiconductor lithography is the formation of three-dimensional relief images or patterns on the semiconductor substrate for subsequent transfer of the pattern to the substrate. In semiconductor lithography, the patterns are formed by a light sensitive polymer called a photo-resist. To build the complex structures that make up a transistor and the many wires that connect the millions of transistors of a circuit, lithography and etch pattern transfer steps are repeated multiple times. Each pattern being printed on the wafer is aligned to the previously formed patterns and slowly the conductors, insulators and selectively doped regions are built up to form the final device.

It is to be understood that other embodiments may be used and structural or logical changes may be made without departing from the spirit and scope defined by the claims. The description of the embodiments is not limiting. In particular, elements of the embodiments described hereinafter may be combined with elements of different embodiments.

### Technical Advantages and Support

It is to be understood that some of the advantages of the present disclosure are provided herein below. However, a person of ordinary skill in the art will appreciate that additional advantages may exist in addition to those described herein.

In an embodiment, a semiconductor package includes a plurality of semiconductor dies joined together by a hybrid bond along an interface surface. A portion of each interface surface of at least two dies of the plurality of semiconductor dies have an inlayed or an embedded structure. A physical unclonable function (PUF) device in the semiconductor package includes the portion of each interface surface of the at least two dies of the semiconductor package having their inlayed or embedded structure aligned. The inlayed or the embedded structure of each respective interface surface of the PUF device has particulates with a different concentration or a different amount of dispersion. The inlayed or the embedded structure of the interface surface of each die of the PUF device has particulates with a different amount of concentration or a different amount of dispersion. The PUF device provides a more individualized dielectric structure that is unclonable and extremely resistant to reverse engineering due to the uncopiable dispersion of the particulates in the hybrid dielectric material built into each interface. In addition, the hybrid bond of the interface surfaces of the dies provides for different dielectrics to be arranged between metal plates of the inlayed or embedded structures. The PUF device enhances the security features of the semiconductor, and facilitates an easier build than a conventional PUF structure fabricated within and during the construction of a BEOL process near the substrate.

In an embodiment, which may be combined with the preceding embodiment, a plurality of PUF devices are arranged in a semiconductor build. There is more flexibility and easier construction of a semiconductor package to include multiple PUF devices because of the hybrid bonding technique.

In an embodiment, which can be combined with one or more of the preceding embodiments, the interface surface of each die has a fusion bonded interface. Fusion bonded hybrid surfaces eliminate the use of metal in connections between the joined dies/wafers.

In an embodiment, which can be combined with one or more of the preceding embodiments, the inlayed or the embedded structure of the interface surface of each die is a dielectric matrix material doped with the particulates having the different amounts of dispersion. Different types of doping create more variability in individual capacitance of each PUF structure.

In an embodiment, which can be combined with one or more of the preceding embodiments, the dielectric matrix material doped with the particulates in each die of the two or more dies comprises a unique electrical signal profile according to the dispersion of the particulates. The creation of a unique electrical signal profile is enhanced with the doped particulates.

In an embodiment, which can be combined with one or more of the preceding embodiments, the particulates of the dielectric matrix material comprise a suspension of Titanium dioxide (TiO₂) or Titanium nitride (TiN). The TiN or TiO₂ are substances used in semiconductor packages and facilitate different capacitance values of the PUF structures.

In an embodiment, which can be combined with one or more of the preceding embodiments, the particulates of the dielectric matrix material are made of different electrically conductive particle concentrations for each die. The different concentrations create more diversity in capacitance and enhanced security.

In an embodiment, which can be combined with one or more of the preceding embodiments, the dielectric matrix material of the inlayed or embedded structure is arranged to mirror a matching structure in the interface surface of a corresponding die joined together. Enhanced security results from a matching structure.

In an embodiment, which can be combined with one or more of the preceding embodiments, the dielectric matrix material of the inlayed or embedded structure comprises an identifiable capacitive structure. The identifiable capacitive structure provides for a more diverse secure PUF structure.

In an embodiment, which can be combined with one or more of the preceding embodiments, the semiconductor package including the at least one PUF device has two or more differently-sized dies. Differently sized dies can create more diversity in the particulate dispersion for enhanced PUF security.

In an embodiment, which can be combined with one or more of the preceding embodiments, the inlayed or embedded structure of the two or more joined dies are made of different materials for each die. Different materials create more diversity in the particulate dispersion for enhanced PUF security.

In an embodiment, which can be combined with one or more of the preceding embodiments, the PUF device comprises security features based on at least a type of the particulates and an amount of the particulates of the interface surface of each die of the two or more dies joined together. The increased diversity due to the type and amount of particulates enhanced the PUF security.

In an embodiment, which can be combined with one or more of the preceding embodiments, the inlayed or embedded structure of the portion of each interface surface of the PUF device is made of different materials. Different materials enhance the unclonability of the PUF device as the dispersion of particulates in the dielectric matrix is unique for each PUF structure.

In an embodiment, which can be combined with one or more of the preceding embodiments, the inlayed or embedded structure of the portion of each interface surface of the PUF device is made of the same materials having different compositions.

In an embodiment, which can be combined with one or more of the preceding embodiments, the inlayed or embedded structure of the portion of each interface surface of the PUF device is made of the same materials having different concentrations. Different concentrations enhance diversity and resultant PUF security.

In an embodiment, a method of manufacturing a semiconductor package includes providing a plurality of semiconductor dies. Each die has an interface surface, and the dies is are bonded together at the interface surface. A physical unclonable function (PUF) device is arranged in at least two of the plurality of semiconductor dies along a portion of the interface surface of the die, each portion of the interface surface of the die having an inlayed or an embedded structure. The PUF device is formed by aligning the inlayed or embedded structure of at least two or more dies of the plurality of semiconductor dies, and joining the two or more dies together. A hybrid bonding technique is used to enhance the security features of the PUF device, and facilitates an easier build than a conventional PUF structure arranged in a BEOL process near the substrate.

In an embodiment, which can be combined with the preceding embodiment, the joining together of the at least two semiconductor dies is performed by fusion bonding or hybrid bonding. Each type of bonding creates more diverse PUF structures to enhance security of the semiconductor package.

In an embodiment, which can be combined with one or more of the preceding embodiments, the forming of the inlayed or the embedded structure of the interface surface includes providing a dielectric matrix material built onto plates within a Back End of Line (BEOL) dielectric stack doped with particulates having different amounts of dispersion. More enhanced PUF structures occur with more diversity of the dielectric material.

In an embodiment, which can be combined with one or more of the preceding embodiments, the inlayed or the embedded structure of the interface surface is embedded with a dielectric matrix material having different compositions or mixes of electrically conductive particles built onto plates within a Back End of Line (BEOL) dielectric stack. Increased diversity results in a more secure PUF structure.

In an embodiment, which can be combined with one or more of the preceding embodiments, the provided semiconductor dies forming are differently sized. The differently-sized dies add to the diversity of the PUF structures for enhanced security.

### Overview

The present disclosure is generally directed to a hybrid bonded physical unclonable function (PUF) device. Traditionally, a PUF is built in a back end of the line (BEOL) stack. Such construction is disruptive to the manufacturing process. For example, in the dielectric build step, the manufacturing has to stop and obtain unique masks to open up this area and deposit the material. According to an embodiment of the present disclosure, a semiconductor package includes a dielectric material built onto metal plates with a BEOL dielectric stack. The dielectric material has electrically conductive particles dispersed within. The metal plates of different BEOL dielectric stacks are joined through hybrid bonding or fusion semiconductor bonding, creating a capacitor-like structure. The random dispersion of the electrically conductive particles within the dielectric material creates a capacitive spread that may be leveraged into creating a unique access key to the chip or device.

The semiconductor package including PUF device according to the present disclosure has a number of advantages over a conventional PUF structure. The PUF device is more easily detectable through the application of electrical signals. In terms of information security, the PUF device of the present disclosure is difficult to hack or bypass (e.g., tamper proof), and may be tied to a kill switch or circuit to shut down a device that is being tampered with. The PUF structure may be used for restrictive programming. In addition, there may be a quantity of redundant cells that can be combined to make larger devices tamper-resistant.

Additional attributes of the semiconductor package having the PUF device according to the present disclosure includes the ability to create different PUF structures as compared to the conventional builds. There may also be better yields by building thin oxide structures on separate wafers. The use of dissimilar materials, and the optional use of coating, simplifies the construction of more complex PUF structures. Also, the integration of the PUF security features in a semiconductor build may occur late or later in the integration process. For example, PUF structures can be added at a later time or at a different processing location to result in enhanced security of the build/manufacture of the device protected by the PUF.

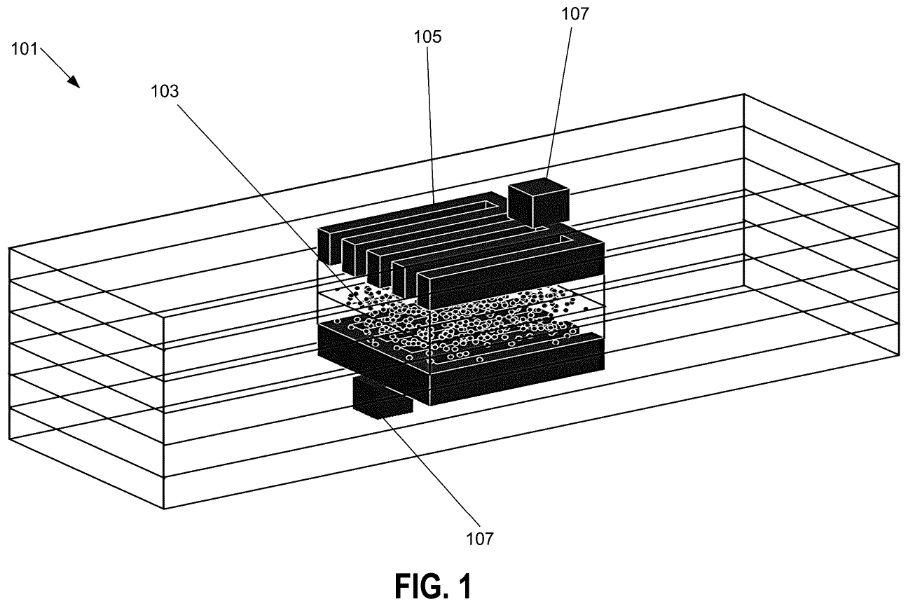

FIG. 1 is an overview of a hybrid bonded physical unclonable function (PUF) structure, consistent with an illustrative embodiment. The PUF structure 101 is shown in perspective view. The PUF structure 101 is arranged within a semiconductor package. The PUF device is formed by two halves of the PUF structure 101 joined together, for example, by hybrid bonding. The PUF structure 101 includes fingers 105 on each half of the PUF structure 101. There are shown dispersion particles 103 of a dielectric material. In this illustrative embodiment, the plates are an arrangement of fingers 105 on the upper and lower part of the PUF structure 101. Solid contiguous plates may be used instead of the fingers 105. However, there is a more efficient distribution of the dispersion particles 103 with the use of the fingers 105.

Electrode pads 107 may be electrically coupled to the fingers 105. The concentration and types of dispersion particles 103 cause each PUF structure 101 to have a unique fingerprint (e.g., in terms of capacitance). In this overview, the dispersion particles 103 of the dielectric material has naturally occurring variations of individual devices during manufacturing and processing. The dielectric material may be a matrix doped with particulates such as TIO₂, TIN, etc., in suspension. Some of the particulates within the suspension of the dielectric matrix structure are electrically conducting or doped. The doped or electrically conductive particulates within the suspension of the dielectric matrix structure results in the creation of an electrical signal profile variability that is inherent and exclusive to each individual security device.

Additional variations to increase the uniqueness of each PUF structure 101 includes different compositions or mixtures of electrically conductive particulates. The overall dimension of the portions of the PUF structure 101 that are bonded together may have different overall dimensions (X, Y, Z) to create variability for each different PUF structure. Different material sets combined during bond and assembly will also result in creating variability. The dielectric matrix structure may be bonded by fusion bonding-oxide-to-oxide.

The semiconductor package include the PUF device according to the present disclosure has many advantages over known PUF structures. A conventional PUF structure is arranged close to the substrate in a Back End Of Line (BEOL) stack, and is susceptible to other components being damaged from bonding that uses heat. The conventional PUF build is disruptive to the BEOL process and requires special masks. In contrast, the PUF device of the present disclosure may be arranged toward the top of a stack, and the joining of two or more interface surfaces that are inlayed or embedded is a less complicated construction with improved security features due to the variability of the two or more dies having PUF interface surfaces of different constructions that may be joined together. The PUF device may be constructed through fusion or hybrid bonding. Moreover, the hybrid structure may be constructed as a wafer-to-wafer, die-to-wafer, or die-to-die structure that provides for far more flexibility than known heretofore. In addition, the dielectric material used for the interface surface of the two or more dies or wafers to form the hybrid structure may be “painted” on an upper surface of a semiconductor surface.

### Example Embodiment(s)

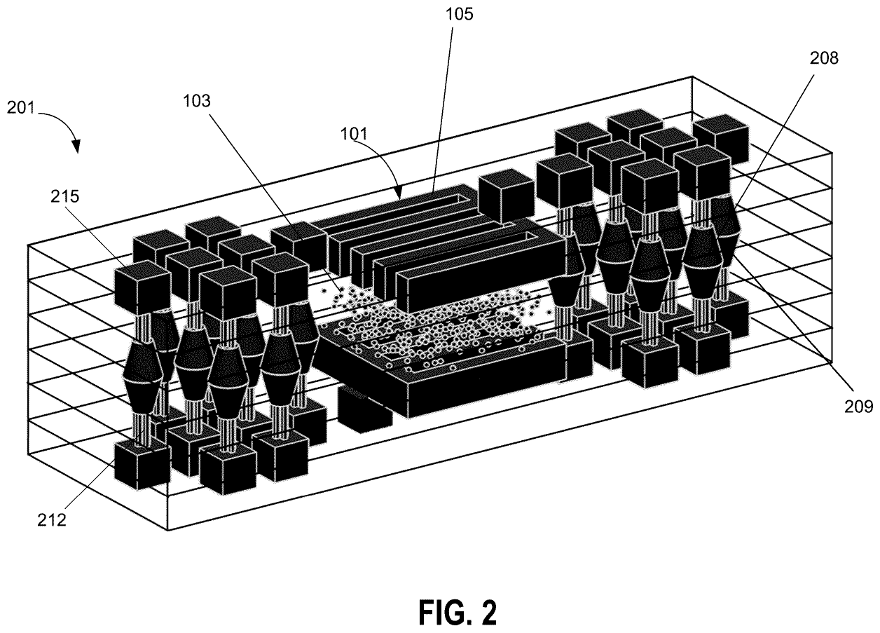

FIG. 2 is a perspective view of a semiconductor package 201 having a PUF structure 101, consistent with an illustrative embodiment. The semiconductor package 201 includes at least one PUF structure 101 such as shown in FIG. 1. The PUF structure 101 may be a hybrid bonded structure or a fusion bonded structure. Hybrid copper pads 208, 209 form a hybrid joining interface, and dielectric posts 212 extend to pads 215. The PUF structure 101 has a unique capacitance that must be known to access the semiconductor package. The uniqueness of each PUF structure 101 makes hacking the semiconductor package 201 virtually impossible, and it is very difficult to reverse engineer a semiconductor package 201 with such a PUF structure 101.

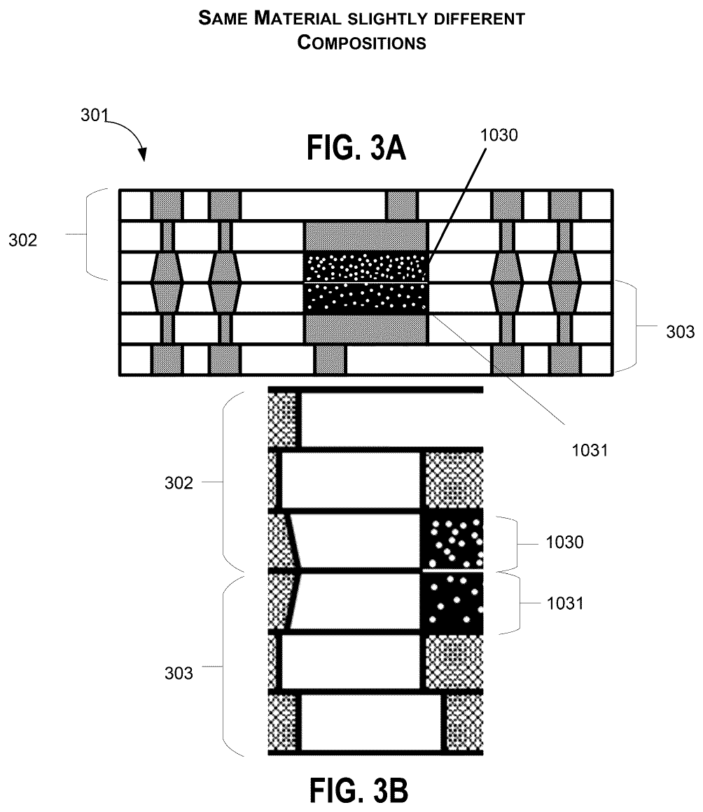

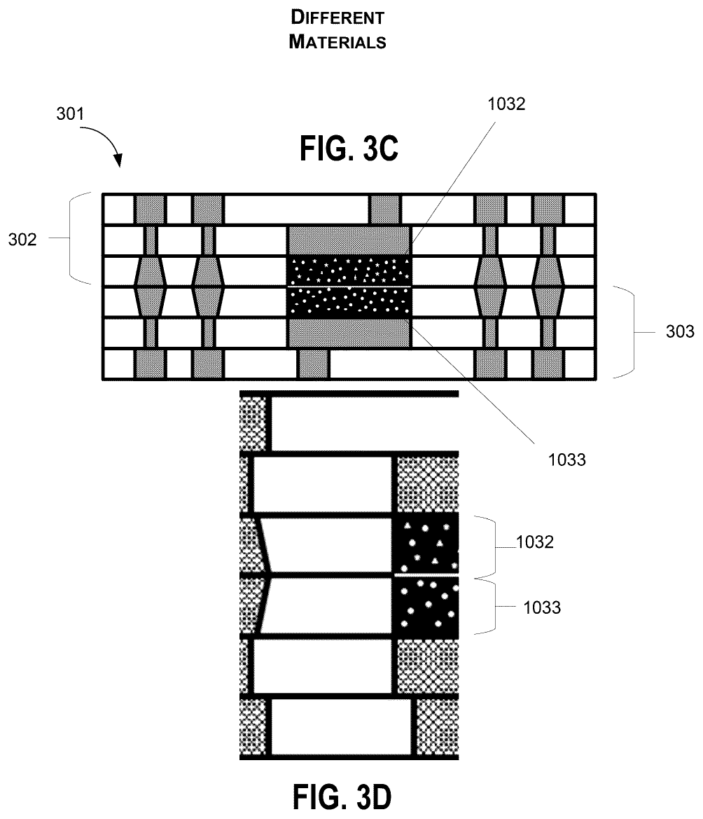

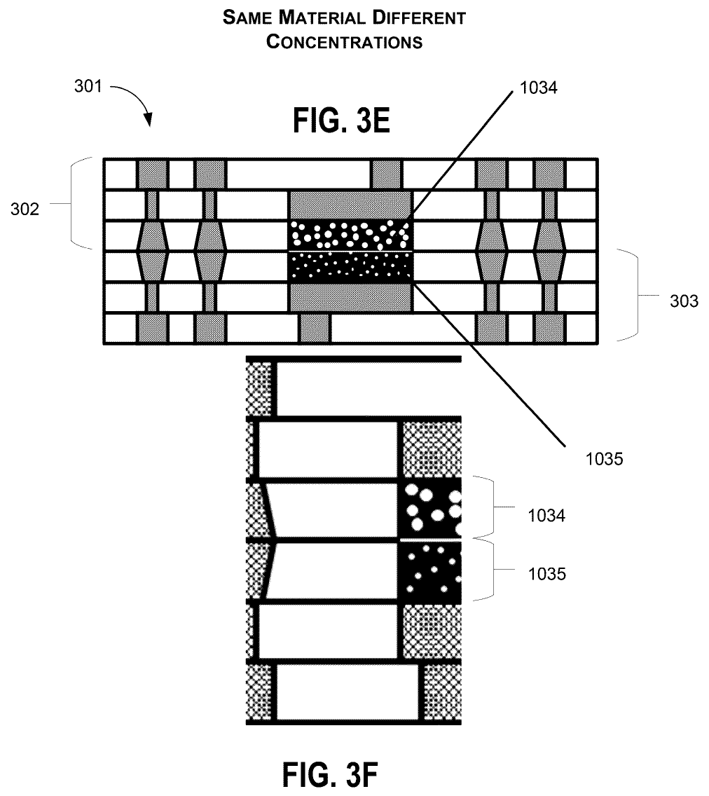

FIGS. 3A and 3B show a front view and a cross-sectional side view, respectively, of a semiconductor package with a PUF device constructed of the same material with slightly different compositions, consistent with an illustrated embodiment. The PUF structure 301 includes a top die 302 and a bottom die 303 that are hybrid bonded or fusion bonded. The material compositions in the top die 302 and the bottom die 303 are different. Dielectric matrix 1030 is slightly different in composition than dielectric matrix 1031, as shown by the different amounts of dots representing particle dispersion.

FIGS. 3C and 3D show a front view and a cross-sectional side view of a semiconductor package with a PUF structure 301 constructed of different materials, consistent with an illustrated embodiment. In this case, the dielectric materials are different dielectrics 1032, 1033. The different material result in a PUF structure 301 with a larger variability in capacitance values, making hacking of the semiconductor package in which the PUF structure is integrated into virtually impossible to hack or reverse engineer.

FIGS. 3E and 3F show a front view and a cross-sectional side view, respectively, of a semiconductor package with a PUF structure 301 constructed of the same material with different concentrations, consistent with an illustrated embodiment. The top die 302 and the bottom die 303 have the same material in different concentrations 1034, 1035. The different size dispersion particles in 1033, and 1034 represent the different concentrations.

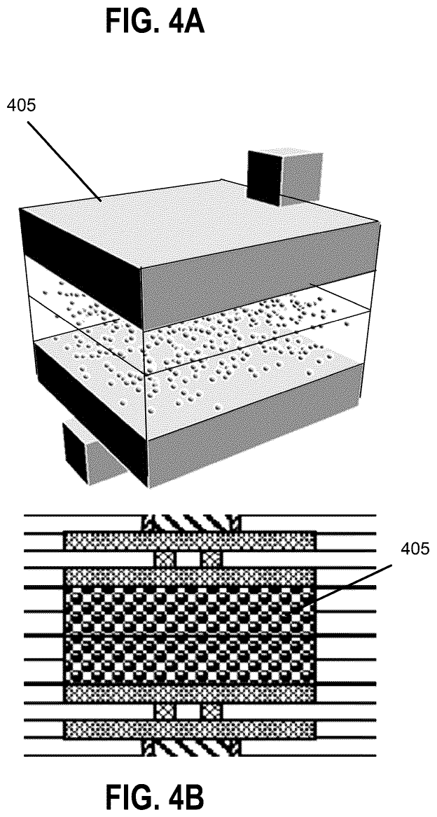

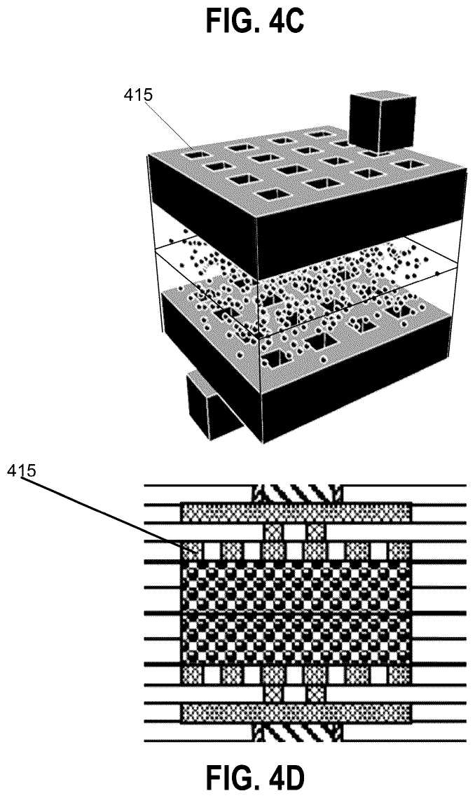

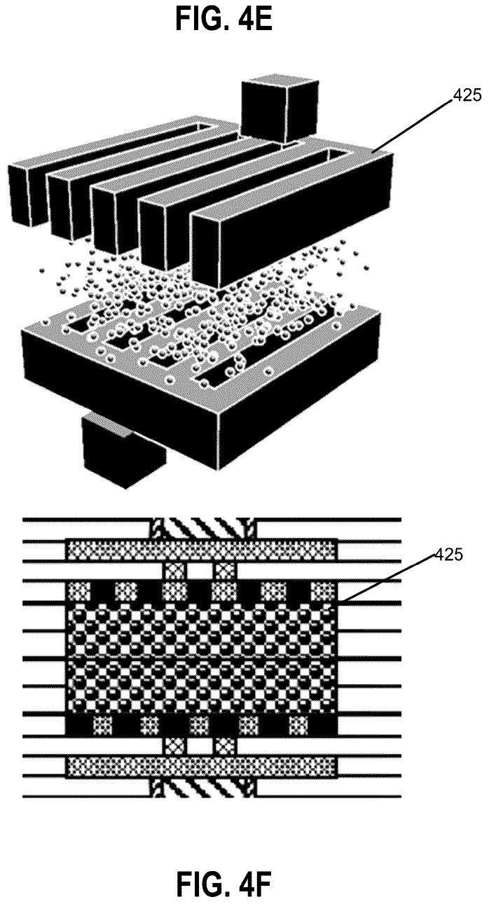

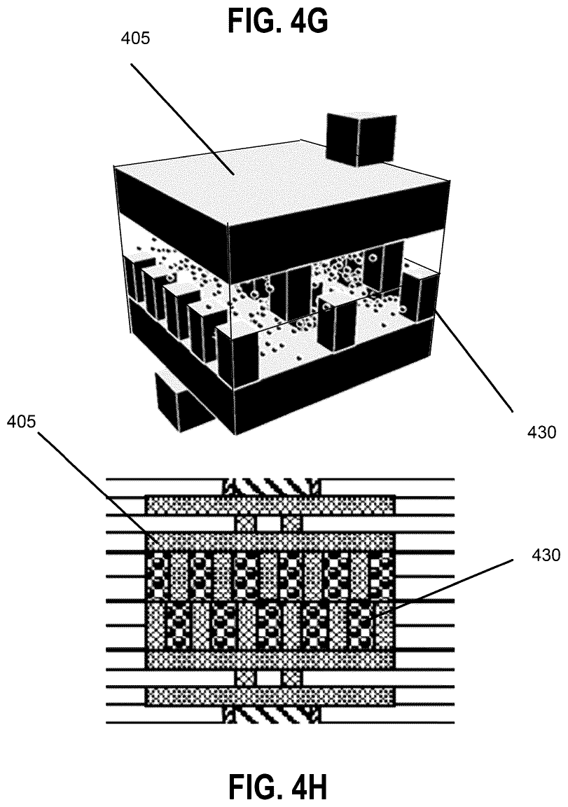

FIGS. 4A and 4B illustrate a perspective view and a cross-sectional side view, respectively, of a first variant of pads in a PUF structure, consistent with an illustrated embodiment. FIGS. 4A and 4B show differently-shaped plates as opposed to the finger electrodes shown in FIG. 1 and FIG. 2. In FIG. 4A the electrodes 405 at the top and bottom of the PUF structure are solid. The PUF structure will have a different dielectric characteristic with the solid electrodes 405 in FIG. 4A, versus the pattern of openings in the electrodes 415 shown in FIG. 4B.

FIGS. 4C and 4D illustrate a perspective view and a cross-sectional side view, respectively, of a second variant of pads in a PUF structure, consistent with an illustrated embodiment. In FIG. 4C and FIG. 4D, the electrodes 415 have openings, which are arranged in an array. The openings 417 affect the dispersion particles of the dielectric material.

FIGS. 4E and 4F illustrate a perspective view and a cross-sectional side view, respectively, of a third variant of pads in a PUF structure, consistent with an illustrated embodiment. In FIGS. 4E and 4F, the electrode finger arrangement 425 is similar to the arrangement shown in FIGS. 1 and 2.

FIGS. 4G and 4H illustrate a perspective view and a cross-sectional side view, respectively, of a fourth variant of pads in a PUF structure, consistent with an illustrated embodiment. In FIG. 4G and FIG. 4H, the electrodes 405 on the top and bottom are solid structures but there are additionally vertical column structures 430 arranged to protrude from the surface of electrodes 405. These vertical column structures 430 affect the variability of the dispersion particles of the dielectric materials, as compared to other electrode structure arrangements.

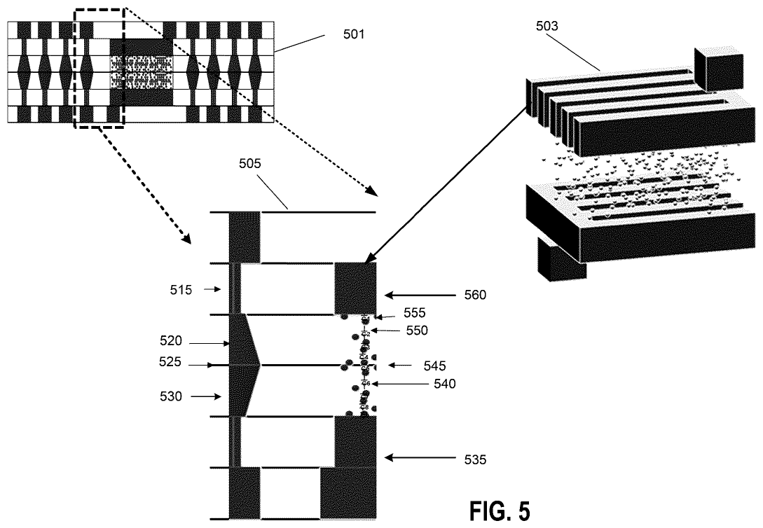

FIG. 5 illustrates the structure of a semiconductor package having a PUF device, and includes some physical variations that enhance the security of the semiconductor package, consistent with an illustrated embodiment. The PUF device has unique variations from the particle dispersion. Such PUF structures are unclonable, as each has a physically-defined fingerprint. A unique cryptographic key special to each IC build is created based on test signals applied to measure a capacitance of each PUF structure. FIG. 5 shows a top-down/perspective view 503 and an enlarged section 505 of a front view of a PUF structure 501, consistent with an illustrated embodiment. A bottom finger electrode 535 and a top finger electrode 560 are shown. The dielectric material includes a randomly dispersed TiN particle 555, and a dielectric Aluminum Phosphate matrix layer 550. A hybrid joining surface 545 is where two dies or wafers are joined. A top hybrid bond copper pad 520 and a bottom copper hybrid bond pad 530 are joined at a hybrid bond interface 525. A specific input challenge results in a unique output response specific to the PUF structure. A unique capacitance 540 is created when combined with other capacitance paths (lateral coupling). A capacitive network spread creates a unique measurement for the PUF structure to serve as a security device.

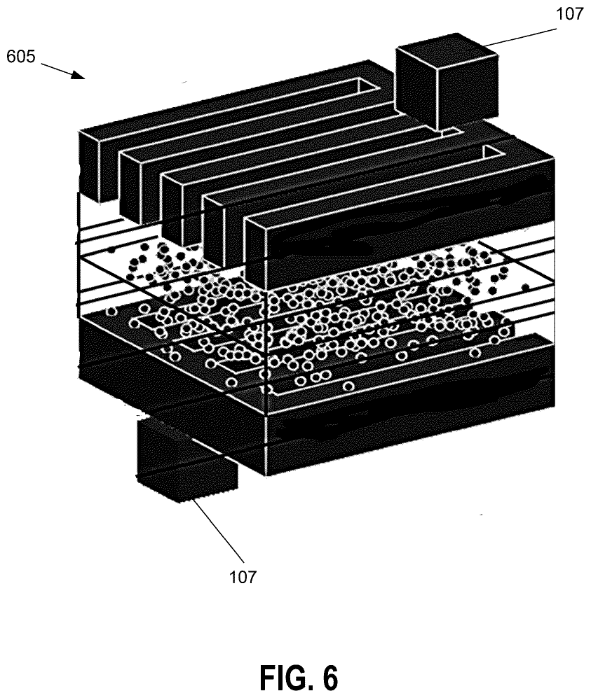

FIG. 6 illustrates the capacitive coupling of an interlocking finger pattern and coating layer of a PUF security device, consistent with an illustrated embodiment. The interlocking finger pattern 605 and a coating layer on the finger pattern may optimize the spread in capacitance across the capacitor structure. Electrode pads 107 are electrically coupled to the fingers pattern. Chip security and data storage in which an unlock key algorithm is generated from capacitors, which are physically linked to the chip in an inseparable way.

### Example Process

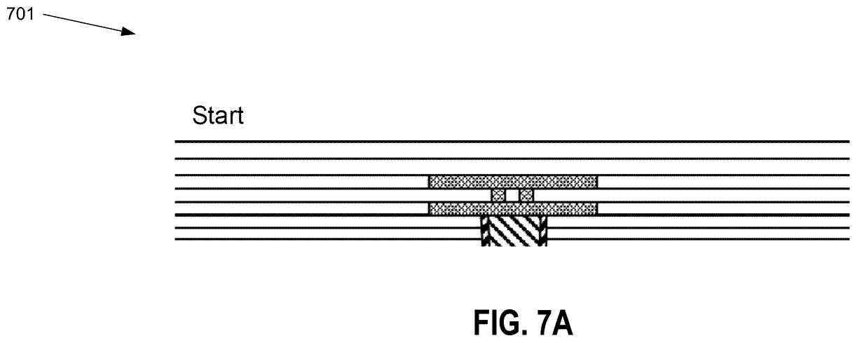

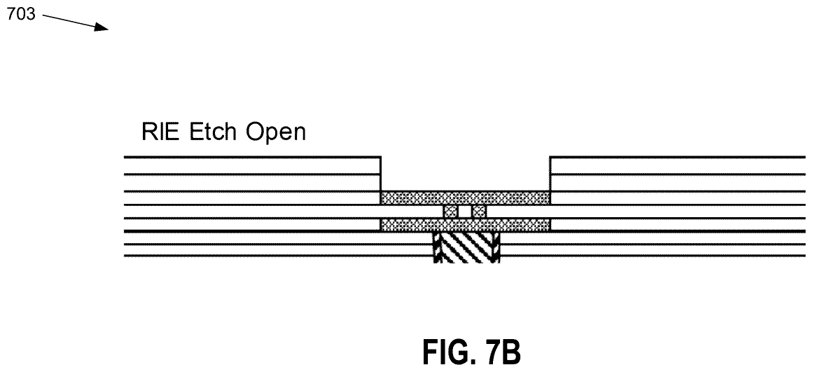

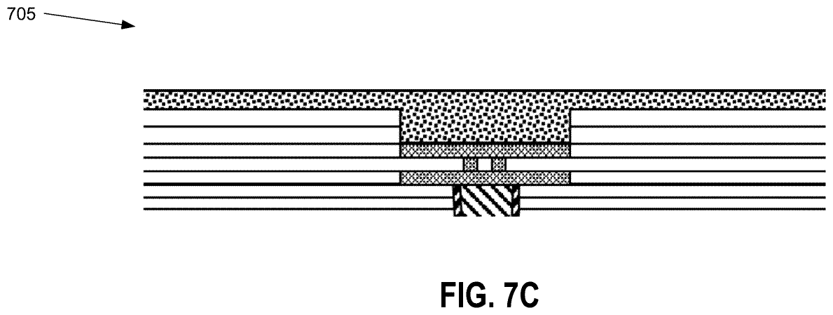

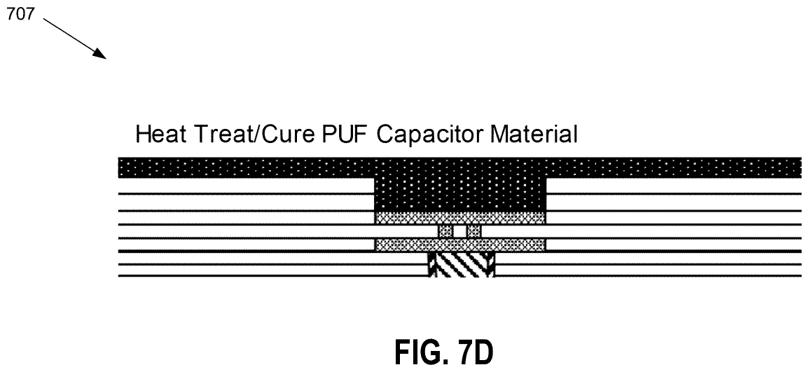

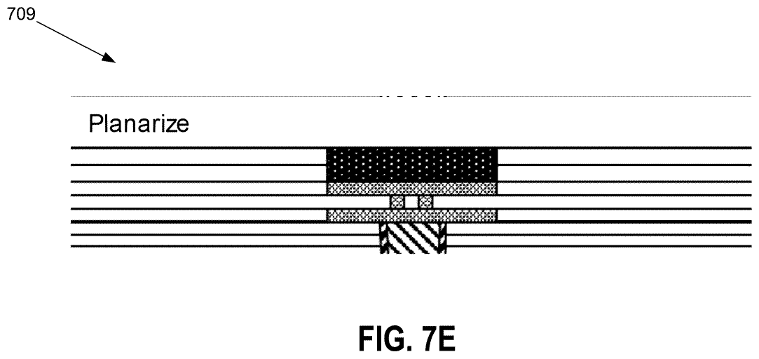

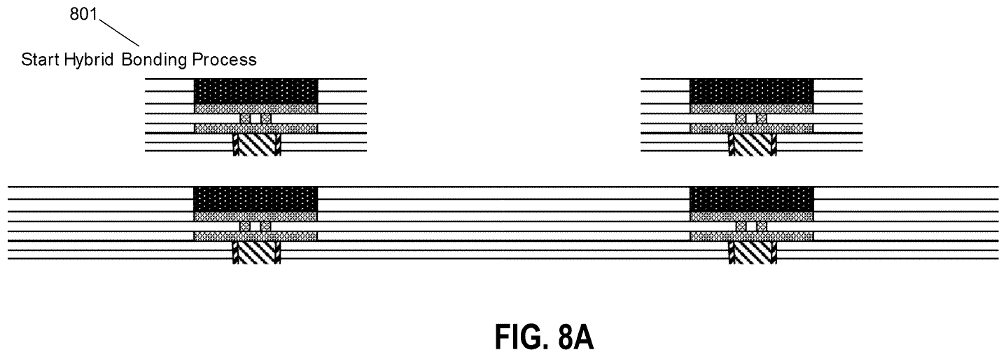

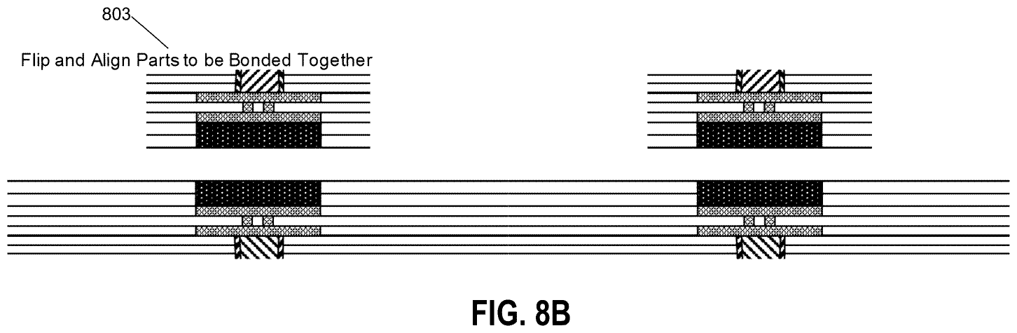

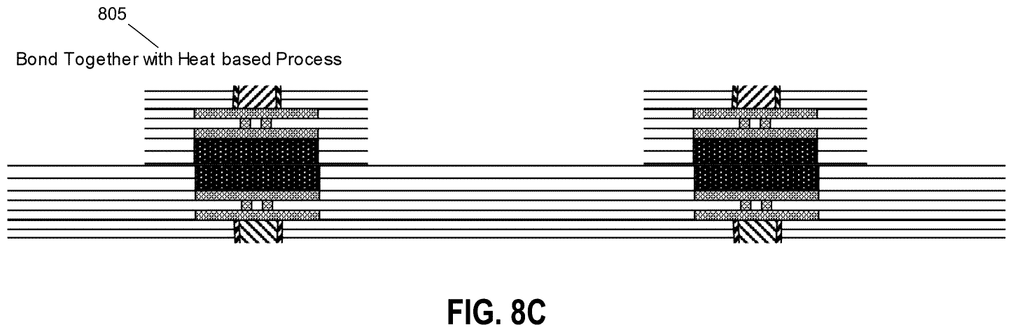

With the foregoing overview of the example architecture, it may be helpful now to consider a high-level discussion of an example process. To that end, FIGS. 7A to 7E and 8A to 8C are process flows illustrating a method of constructing a semiconductor package with a PUF structure, consistent with an illustrative embodiment. FIGS. 7A to 7E illustrates different stages of a process flow for the fabrication of a PUF structure, consistent with an illustrative embodiment, and FIGS. 8A to 8C illustrate different stages of a process flow for a hybrid bonding process to join two halves (e.g., builds) of a PUF structure, consistent with an illustrative embodiment.

With regard to the process flow in FIGS. 7A to 7E, there is a start of the process flow where two plates are arranged in a substrate with a pad (operation 701). Reactive ion etching (RIE) is then performed to open the substrate to permit a build of a PUF structure (operation 703 in FIG. 7B). Capacitive material in the form of particulates (e.g., particles with a different amount of dispersion) is then arranged both in the RIE etch opening, and along an upper surface of the substrate (operation 705 in FIG. 7C). The capacitive material may be a dielectric material, and is in contact with one of the plates.

Next a heat treatment/curing operation of the PUF capacitor dielectric material is performed (operation 707 in FIG. 7D). After the heating operation, the cured PUF capacitor material is planarized to remove the material along the surface of the substrate (operation 709 in FIG. 7E).

The aforementioned operations are used to process one-half of a PUF structure. The same or similar operations are performed to create another half of the PUF structure, and one of the semiconductor dies is flipped onto the other. Then, a hybrid bonding or a fusion bonding operation is performed to create a PUF structure.

FIGS. 8A to 8C illustrate different stages of a process flow for a hybrid bonding process to join two halves of a PUF structure, consistent with an illustrative embodiment. The bonding process begins at operation 801 in FIG. 8A. Two or more PUF halves (e.g., there may be wafer-to-die joined structures with two dies joined to one wafer) may be manufactured according to the process illustrated in FIGS. 7A to 7E.

Referring now to FIG. 8B, one of the PUF structures is flipped over and aligned with another half-PUF structure (operation 803). The planarized surface of each PUF structure may be referred to as an interface surface. The aligned half PUF structures are bonded together with a heat-based process (operation 805 in FIG. 8C). It should be appreciated that the semiconductor die shown in FIG. 8C may have other components in addition to the PUF structures shown, such as the top and bottom hybrid copper pads, TSVs, electrode pads, etc., such shown in FIG. 2.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to better explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

It is to be understood that in the case of a fusion direct bonded structure (oxide to oxide), there are no metal connectors in the interface of the connected dies, and the signals pass exclusively through the PUF structures. A variety of individual devices can be varied in many ways through the various structure parameters discussed herein and manufacturing. This variability can be easily detected/classified through a number of electrical tests. Various spectroscopy may also be employed to identify and classify the PUF security structure. For example a 10-20% variance results in about a 10% variance in the threshold voltage (VT).

In addition, the electrically enhanced dielectric material of structures includes different compositions and concentrations. With regard to compositions, an electrical variance range is detectable at a 2% concentration change. Different dielectric material combinations at a joint will result in a minimum of 20-35% variation.

With regard to compositions, a minimum 66% variation is achieved with a slight concentration change. A random dopant fluctuation (RDF) of +10% results in a variation of 100 mV in VT0, 15% in transconductance parameters (K′), and 5% in the source-bulk (CSB) and the drain-bulk (CDB) junction capacitances.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A semiconductor package comprising:
a plurality of semiconductor dies joined together by a hybrid bond along an interface surface, wherein a portion of each interface surface of at least two dies of the plurality of semiconductor dies comprises an inlayed or an embedded structure; and
a physical unclonable function (PUF) device comprising the portion of each interface surface of the at least two dies having the inlayed or embedded structure aligned together,
wherein the inlayed or the embedded structure of each respective interface surface of the PUF device has particulates with a different concentration or an amount of dispersion.

2. The semiconductor package according to claim 1, comprising a plurality of PUF devices arranged in a semiconductor build.

3. The semiconductor package according to claim 1, wherein the interface surface of each die comprises a fusion bonded interface.

4. The semiconductor package according to claim 1, wherein the inlayed or the embedded structure of the interface surface of each die comprises a dielectric matrix material doped with the particulates having the different amount of dispersion.

5. The semiconductor package according to claim 4, wherein the dielectric matrix material doped with the particulates in each die of the two or more dies comprises a unique electrical signal profile according to the dispersion of the particulates.

6. The semiconductor package according to claim 4, wherein the particulates of the dielectric matrix material comprise a suspension of Titanium dioxide (TiO₂) or Titanium nitride (TiN).

7. The semiconductor package according to claim 4, wherein the particulates of the dielectric matrix material comprise different electrically conductive particle concentrations for each die.

8. The semiconductor package according to claim 4, wherein the dielectric matrix material of the inlayed or embedded structure is arranged to mirror a matching structure in the interface surface of a corresponding die joined together.

9. The semiconductor package according to claim 4, wherein the dielectric matrix material of the inlayed or embedded structure comprises an identifiable capacitive structure.

10. The semiconductor package according to claim 1, comprising two or more differently-sized dies.

11. The semiconductor package according to claim 1, wherein the inlayed or embedded structure of the portion of each interface surface of the PUF device comprises different materials for each die.

12. The semiconductor package according to claim 1, wherein the PUF device comprises security features based on at least a type of the particulates and an amount of the particulates of the interface surface of each die of the two or more dies joined together.

13. The semiconductor package according to claim 1, wherein the inlayed or embedded structure of the portion of each interface surface of the PUF device comprises different materials.

14. The semiconductor package according to claim 1, wherein the inlayed or embedded structure of the portion of each interface surface of the PUF device comprises a same material having different compositions.

15. The semiconductor package according to claim 1, wherein the inlayed or embedded structure of the portion of each interface surface of the PUF device comprises a same material having different concentrations.

16. A method of manufacturing a semiconductor package, the method comprising:
providing a plurality of semiconductor dies having interface surfaces;
providing a portion of each of the interface surfaces with an inlayed or embedded structure with particulates having different concentrations or amounts of dispersion;
aligning the inlayed or embedded structures of two or more of the plurality of semiconductor dies; and
joining together two or more of the plurality of semiconductor dies to form a physical unclonable function (PUF) device at a joined portion of each of the interfaces having the inlayed or embedded structure.

17. The method according to claim 16, wherein the joining together of at least two semiconductor dies is performed by fusion bonding or hybrid bonding.

18. The method according to claim 17, wherein forming the PUF device includes providing the portion of each interface surface having the inlayed or the embedded structure with a dielectric matrix material built onto plates within a Back End of Line (BEOL) dielectric stack doped with particulates having different amounts of dispersion.

19. The method according to claim 17, wherein forming the PUF device includes providing the portion of each interface surface having the inlayed or the embedded structure with a dielectric matrix material having different compositions or mixes of electrically conductive particles built onto plates within a Back End of Line (BEOL) dielectric stack.

20. The method according to claim 17, wherein the plurality of semiconductor dies joined together by hybrid bonding to form the PUF device are differently sized.
